(19) United States
(12) Patent Application Publication
(10) Pub. No.: US 2016/0232110 A1
(43) Pub. Date: Aug. 11, 2016

(54) Input Interface Device for Portable Device

(71) Applicant: Action Star Enterprise Co., Ltd., New Taipei City (TW)

(72) Inventor: CHING-WEI CHENG, New Taipei City (TW)

(21) Appl. No.: 14/619,067

(22) Filed: Feb. 11, 2015

(51) Int. Cl. G06F 13/10; G06F 13/42

(52) U.S. Cl. CPC G06F 13/102; G06F 13/4282

(57) ABSTRACT

The present invention provides an input interface device for portable device constituted by a first downstream electrical connection unit, a processing unit and a second downstream electrical connection unit. When the first downstream electrical connection unit is electrically connected to a portable device, the portable device would switch to a device mode thereof; therefore, in spite of the portable device electrically connected to the input interface device does not be carried with any USB OTG chips, an external electronic device such as keyboard can still provide a user for carrying out an input operation after the keyboard is electrically connected to the second downstream electrical connection unit.

### BACKGROUND OF THE INVENTION

1. Field of the Invention

The present invention relates to the technology field of input interfaces, and more particularly to an input interface device for portable device capable of carried out based on low manufacturing cast.

2. Description of the Prior Art

With the development of 3C technology products, tablet PCs and high-level smart phones are getting to replace the traditional notebooks and then become the most popular portable electronic products. However, the tablet PCs and the high-level smart phones cannot provide efficient word processing functionality for users because their word input interface is touch screen.

Accordingly, an USB OTG (On-The-Go) function is then developed and added into the tablet PCs and the high-level smart phones. Please refer to FIG. 1, which illustrates a stereo diagram of a tablet PC, an USB OTG hub, a keyboard, and a mouse. As shown in FIG. 1, after connecting an upstream USB connector 151′ of an USB OTG hub 15′ to a tablet PC 14 and then respectively connecting a keyboard 12′ and a mouse 13′ to two downstream USB connectors 152′, a user is able to complete an efficient word process by operating the table PC 14′ through the keyboard 12′ and the mouse 13′.

When the USB OTG function is added into the tablet PC 14′, an USB OTG chip disposed in the internal of the tablet PC 14′ would automatically drive the keyboard 12′ and/or the mouse 13′ connected to the downstream USB connectors 152′, so as to facilitate the keyboard 12′ and/or the mouse 13′ be operable. However, the conventional USB OTG function still reveal following shortcomings and drawbacks:
(1) It is able to know that, after the tablet PCs 14′ (or the smart phones) are carried with an USB OTG chip, the tablet PCs 14′ can facilitate the connected keyboard 12′ and/or the mouse 13′ become the input interface devices for the users to complete their word processes. However, the selling price of the tablet PCs and the smart phones carried with the USB OTG chip is more expensive than the selling price of the tablet PCs and the smart phones without having the USB OTG chip.
(2) because the character coding input method provide by iOS® system and/or Android® system is different from the traditional character coding input method provide by X86 system, the user still cannot complete the efficient word process by operating the table PC 14′ through the keyboard 12′ and the mouse 13′ since the button positions of the keyboard 12′ are different from the button positions of the virtual keyboard shown on the touch screen of the table PC 14′ (or the smart phones).

Accordingly, in view of the USB OTG function still include drawbacks, the inventor of the present application has made great efforts to make inventive research thereon and eventually provided an input interface device for portable device.

### SUMMARY OF THE INVENTION

The primary objective of the present invention is to provide an input interface device for portable device, wherein this input interface device is consisted of a first downstream electrical connection unit, a processing unit and a second downstream electrical connection unit. When the first downstream electrical connection unit is electrically connected to a portable device, the portable device would switch to a device mode thereof; therefore, in spite of the portable device electrically connected to the input interface device does not be carried with any USB OTG chips, an external electronic device such as keyboard can still provide a user for carrying out an input operation after the keyboard is electrically connected to the second downstream electrical connection unit.

Accordingly, in order to achieve the primary objective of the present invention, the inventor of the present invention provides an input interface device for portable device, comprising:

a first downstream electrical connection unit, used for electrically connecting to an external portable device; a processing unit, coupled to the first downstream electrical connection unit; and a second downstream electrical connection unit, coupled to the processing unit and used for electrically connecting to an external electronic device. When the portable device is connected to the first downstream electrical connection unit, the processing unit would detect whether the portable device is installed with an application program, so as to automatically install the application program in the portable device. Moreover, when the external electronic device is connected to the second downstream electrical connection unit, the application program would automatically carry out a device identification operation for the external electronic device. Furthermore, when the external electronic device outputs an input data signal, the processing unit would execute a character coding operation to the input data signal and then further output a coded data signal to the portable device, such that the application program is able to decode the coded data signal to an input data.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a stereo diagram of a tablet PC, an USB OTG hub, a keyboard, and a mouse;

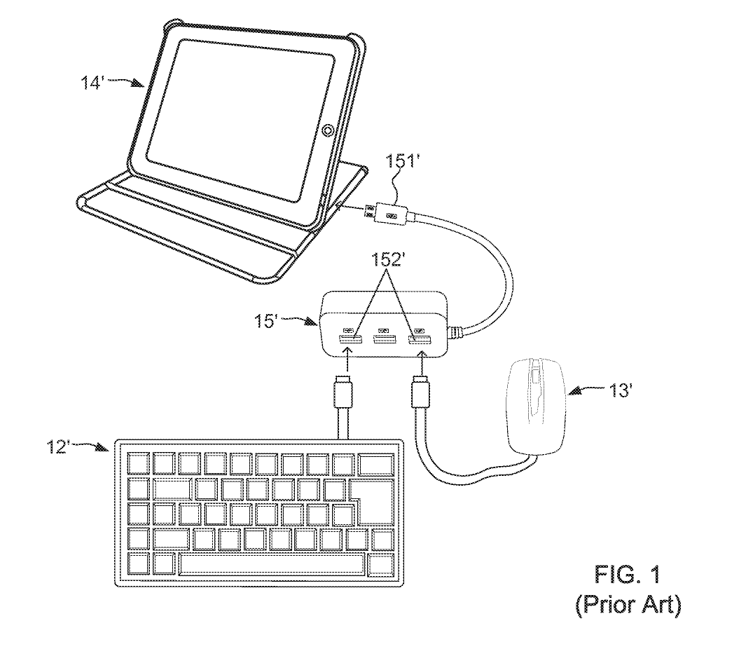

FIG. 2 shows a schematic framework diagram of an input interface device for portable device according to the present invention; and

FIG. 3 shows a schematic application diagram of the input interface device.

### DETAILED DESCRIPTION OF THE PREFERRED EMBODIMENTS

To more clearly describe an input interface device for portable device according to the present invention, embodiments of the present invention will be described in detail with reference to the attached drawings hereinafter.

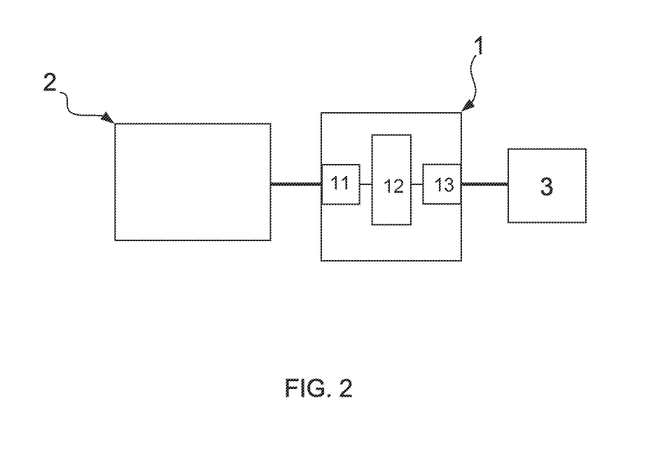

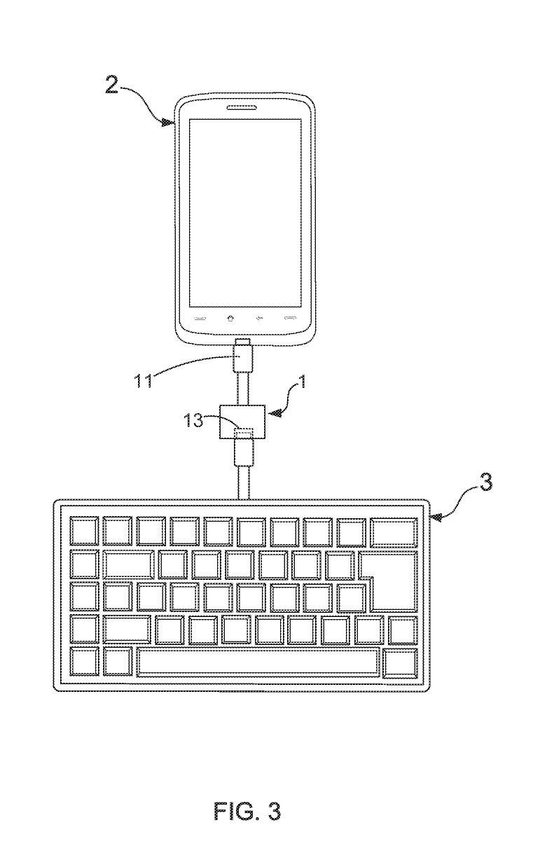

With reference to FIG. 2 and FIG. 3, wherein FIG. 2 shows a schematic framework diagram of an input interface device for portable device according to the present invention, and FIG. 3 illustrates a schematic application diagram of the input interface device. As shown in FIG. 2 and FIG. 3, the input interface device for portable device 1 provided by the present invention consists of: a first downstream electrical connection unit 11, a processing unit 12 and a second downstream electrical connection unit 13; wherein the first downstream electrical connection unit 11 is coupled to the processing unit 12 and used for electrically connecting to an external portable device 2, which can be a micro USB connector compatible to Andriod® portable device or a lighting connector compatible to iOS® portable device. In addition, the second downstream electrical connection unit 13 coupled to the processing unit 12 is an USB electrical connector, used for electrically connecting to an external electronic device 3.

In the present invention, when the portable device 2 is connected to the first downstream electrical connection unit 11, the processing unit 12 would detect whether the portable device 2 is installed with an application program, so as to automatically install the application program in the portable device 2. Of course, users can install the application program in their portable device 2 in advance. Therefore, when an external electronic device 3 such as keyboard is connected to the second downstream electrical connection unit 13, the application program would automatically carry out a device identification operation for the external electronic device 3 (i.e., keyboard). Eventually, when the external electronic device 3 outputs an input data signal, the processing unit 12 would receive the input data signal so as to execute a character coding operation to the input data signal and then further output a coded data signal to the portable device 2, such that the application program is able to decode the coded data signal to an input data.

For example, when the user input a word string by operating the keyboard (i.e., the external electronic device 3), the processing unit 12 would process the word string to a coded data signal and then output the coded data signal to the portable device 2. Therefore, the application program installed in the portable device 2 would subsequently decode the coded data signal to a word string. Eventually, the user can see the word string being shown on the touch screen of the portable device 2.

Besides, when the operating a mouse (i.e., the external electronic device 3) connected to the second downstream electrical connection unit 13, the processing unit 12 would process the cursor motion signal outputted by the mouse to a coded data signal, and then the processing unit 12 outputs the coded data signal to the portable device 2. Therefore, the application program installed in the portable device 2 would subsequently decode the coded data signal, so as to show the cursor motion on the touch screen of the portable device 2. Of course, despite above descriptions merely take the keyboard and the mouse be the external electronic device 3, it should not limit the exemplary embodiments of the external electronic device 3. In other possible applications, the external electronic device 3 can also be a joystick, a handwriting input device, a virtual keyboard projection device, a flash drive, or a card reader.

Therefore, through above descriptions, the input interface device for portable device proposed by the present invention has been introduced completely and clearly; in summary, the present invention includes the advantages of:
(1) In the present invention, an input interface device for portable device constituted by a first downstream electrical connection unit 11, a processing unit 12 and a second downstream electrical connection unit 13 has proposed. When the first downstream electrical connection unit 11 is electrically connected to a portable device 2, the portable device 2 would automatically switch to a device mode; therefore, in spite of the portable device 2 electrically connected to the input interface device 1 does not be carried with any USB OTG chips, an external electronic device 3 such as keyboard can still provide users for carrying out (word string) input operations after the keyboard is electrically connected to the second downstream electrical connection unit 13.
(2) Moreover, the input interface device 1 proposed by the present invention would detect whether the connected portable device 2 is installed with an application program, so as to automatically install the application program in the portable device 2. Thus, when a user finish an input operation by using the external electronic device 3, the processing unit 12 of the input interface device 1 and the application program installed in the portable device 2 would execute a first code transformation operation and a second code transformation operation to the input operation finished by the user, such that the results such as word string or cursor motion made by of the input operation can be shown on the screen of the portable device 2, in spite of the portable device 2 is a Andriod® portable device or a iOS® portable device.

The above description is made on embodiments of the present invention. However, the embodiments are not intended to limit scope of the present invention, and all equivalent implementations or alterations within the spirit of the present invention still fall within the scope of the present invention.

1. An input interface device for portable device, comprising:
a first downstream electrical connection unit, being used for electrically connecting to portable device;
a processing unit, being coupled to the first downstream electrical connection unit; and
a second downstream electrical connection unit, being coupled to the processing unit, and used for electrically connecting to an external electronic device;
wherein when the portable device is connected to the first downstream electrical connection unit, the processing unit would detect whether the portable device is installed with an application program, so as to automatically install the application program in the portable device;
wherein when the external electronic device is connected to the second downstream electrical connection unit, the application program would automatically carry out a device identification operation for the external electronic device;
wherein when the electronic device outputs an input data signal, the processing unit would receive the input data signal so as to execute a character coding operation to the input data signal and then further output a coded data signal to the portable device, such that the application program is able to decode the coded data signal to an input data.

2. The input interface device for portable device of claim 1, wherein the first downstream electrical connection unit is selected from the group consisting of: micro USB connector compatible to Andriod® portable device, lighting connector compatible to iOS® portable device.

3. The input interface device for portable device of claim 1, wherein the second downstream electrical connection unit is an USB electrical connector.

4. The input interface device for portable device of claim 1, wherein the external electronic device is selected from the group consisting of: keyboard, mouse, joystick, handwriting input device, virtual keyboard projection device, flash drive, and card reader.
